(19) United States
(12) Patent Application Publication
(10) Pub. No.: US 2022/0048674 A1
(43) Pub. Date: Feb. 17, 2022

(54) Portable Rail Mounted Container

(71) Applicant: Mark Sexton, Benton, AR (US)

(72) Inventor: Mark Sexton, Benton, AR (US)

(21) Appl. No.: 16/994,306

(22) Filed: Aug. 14, 2020

(51) Int. Cl. B65D 25/22; B65D 1/24; B65D 21/02

(52) U.S. Cl. CPC B65D 25/22; B65D 21/0233; B65D 1/24

(57) ABSTRACT

A portable rail mounted storage container to be used with construction equipment. It has a storage body with one or more compartments and attached via an attachment bracket to the corner of the railing of a piece of construction equipment. Once attached, it can provide tools and materials to the user without taking up space in other areas of the equipment and can put the tools and materials in a known and convenient location.

### BACKGROUND OF THE INVENTION

The present invention is in the technical field of portable storage containers. More particularly, the present invention is in the technical field of portable storage containers which may be attached or mounted to rails, More particularly, the present invention is in the technical field of portable storage containers which may be attached or mounted to safety rails of construction equipment.

### SUMMARY OF THE INVENTION

The present invention is a portable container for attachment to the safety railing of construction equipment having a body with one or more compartments, an attachment bracket for removably mounting the container to the railing, and an accessory rail.

The advantages of the present invention include, without limitation, that it is simple in operation such, that it is intuitive to the user. Additionally, the present invention is simple to produce.

In broad embodiment, the present invention is a container that may be quickly statically attached to safety railing which is commonly found on construction equipment and removably secured.

### BRIEF DESCRIPTION OF THE DRAWING

These and other features, aspects, and advantages of the present invention will become better understood with regard to the following description, appended claims, and accompanying drawings where

FIG. 1 is a top-right perspective view of a portable rail mounted container of the present invention;

FIG. 2 is a top view of a portable rail mounted container of the present invention.

FIG. 3 is a bottom view of a portable rail mounted container of the present invention;

FIG. 4 is a front view of a portable rail mounted container of the present invention.

FIG. 5 is a right side view of a portable rail mounted container of the present invention.

FIG. 6 is a left side view of multiple portable rail mounted containers of the present invention.

### DETAILED DESCRIPTION OF THE INVENTION

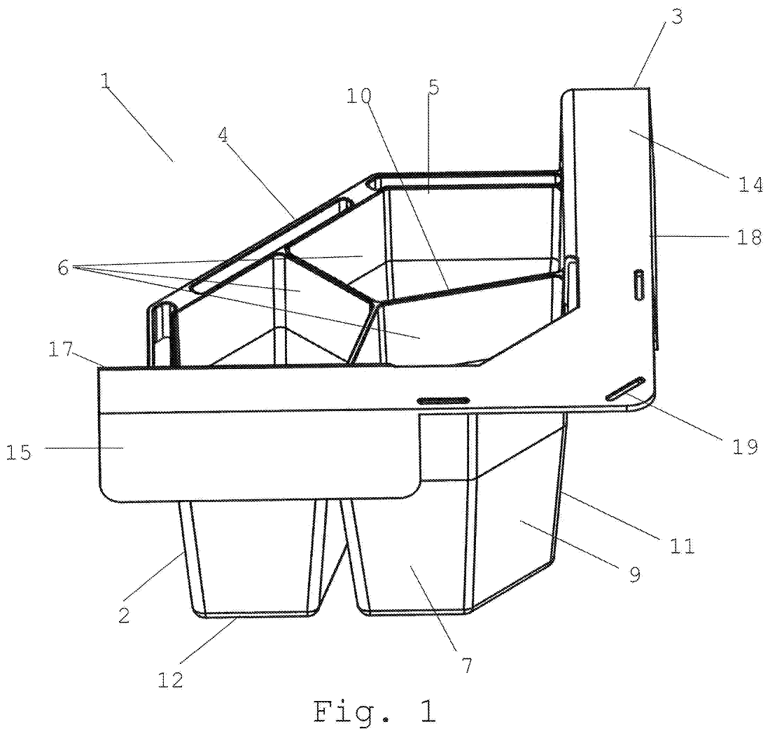

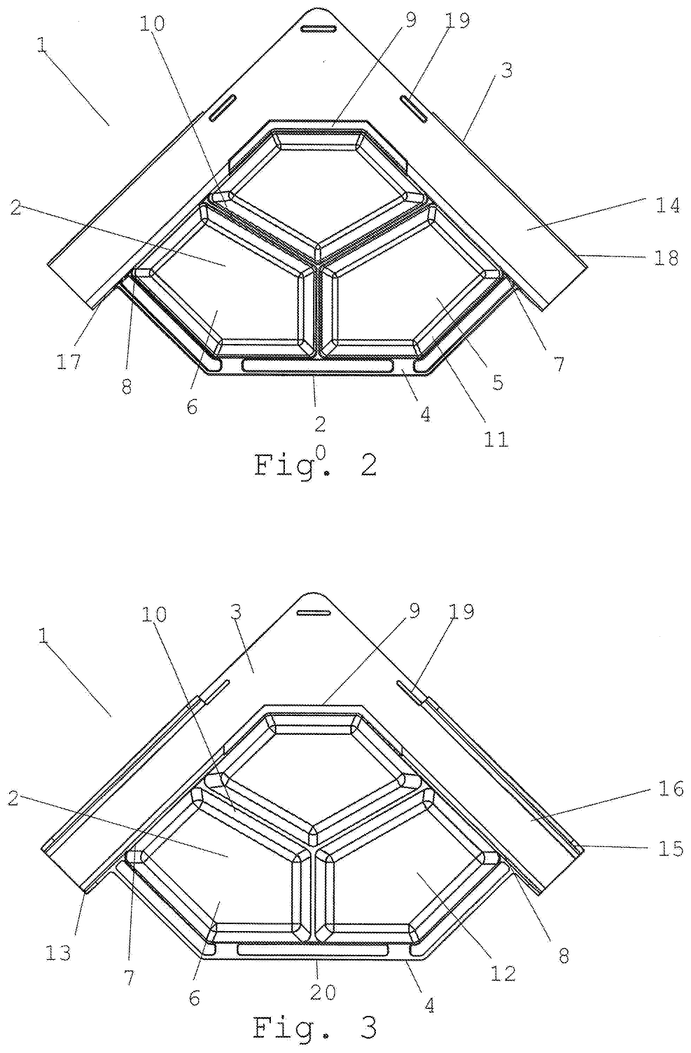

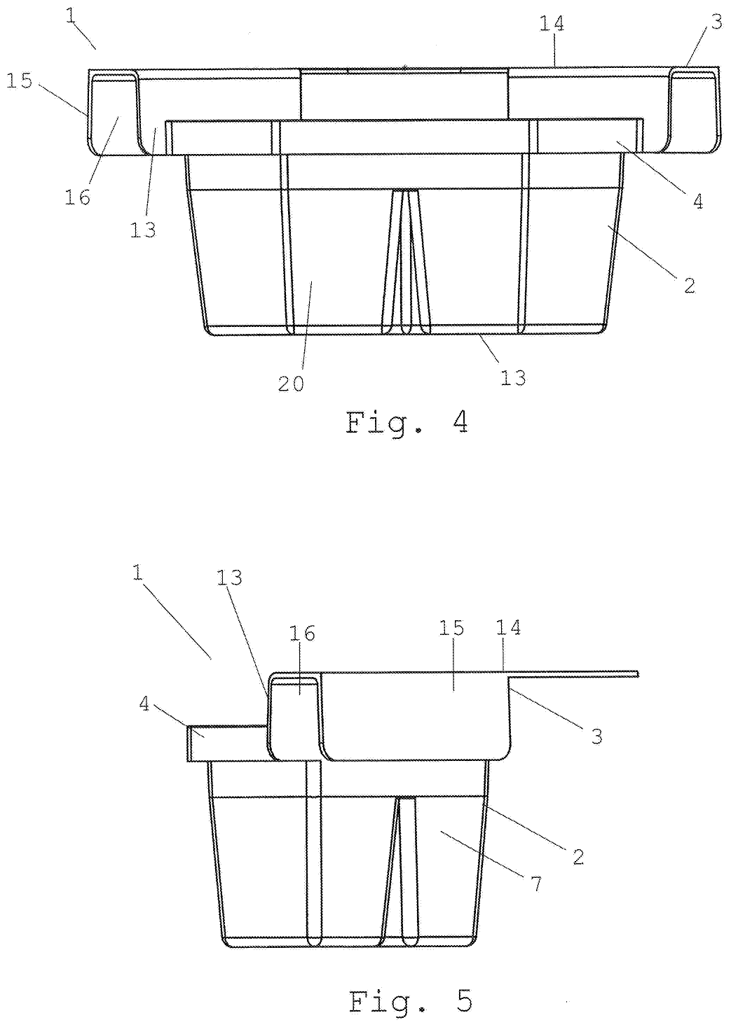

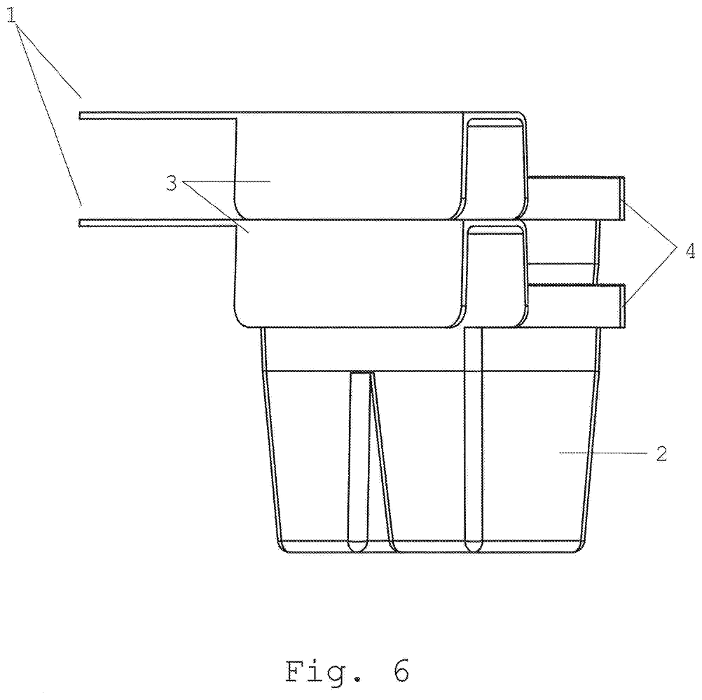

Referring to the drawings, FIG. 1-5 depict an embodiment of portable rail mounted container 1 having a storage body 2, an attachment bracket 3, and an accessory rail 4. The preferred embodiment of the container 1 is constructed of a semi-rigid polymer such that all of the components are molded as a single piece. The container 1 may be constructed of any rigid or semi-rigid material and may also be constructed of multiple pieces.

The storage body 2 is generally concave in shape with an open top 5. The storage body comprises one or more compartments 6 with the preferred embodiment having three compartments. The storage body further comprises a right rear outer side 7 and a left rear outer side 8 which are generally located at the rear 9 of the container and are substantially perpendicular to one another as viewed from the top or bottom. The storage body may also comprise one or more dividers 10 on which separate the individual compartments from one another. The walls 11 of the storage body are preferable tapered such that the storage body and compartments are narrower at the bottom 12 of the storage body than at the top 5 such that multiple containers will stack in a way that a container will nest into the container below as depicted in FIG. 6. However, the walls 11 may he configured parallel to one another such that the storage body 2 is of a consistent size from the bottom 12 to the top 5.

The attachment bracket 3 is located proximate to and is affixed to the right and left rear outer sides 7, 8 of the storage body 2. The attachment bracket consists of one or more inner tabs 13, a top surface 14, and one or more outer tabs 15 and are configured such that a channel 16 is formed with the rough cross section of an inverted U. The inner tabs 13 are affixed to the right and left rear outer sides 7, 8 of the storage body 2 and extend vertically therefrom. The top surface 14 has an inner edge 17 and an outer edge 18 and is affixed to the inner tabs 13 via the inner edge 17 and extends perpendicularly outward from the inner tabs as generally depicted in FIGS. 1-5. The top surface 14 is preferably configured as an L shape with a right angle and an inner edge and an outer edge. The outer tabs 15 are affixed to the top surface 14 and extend downward perpendicularly from the top surface 14 such that the outer tabs 15 are substantially parallel to the inner tabs 13. The attachment bracket 3 is preferably configured such that the inner and outer tabs are extend an equivalent amount below the top surface, but they may extend different amounts. The attachment bracket 3 further comprises one or more perforations 19 which may be located anywhere on the top surface or the inner and outer tabs, The perforations 19 are preferably configured as slots or round holes but may take other shapes as well.

The accessory rail 4 is located proximate the front 20 of the container and the top 5 of the storage body 2 and is affixed to the storage body 2 at multiple points and affixed at its ends to the inner tabs 13 of the attachment bracket 3. The accessory rail 4 is configured such that it generally follows the outside contours of the storage body 2 and is preferably positioned such that there is a space between it and the storage body 2. The accessory rail 2 is preferably generally flat in shape with a generally rectangular cross section, but may have other cross sections

The present invention is configured to be used with construction equipment with safety railing to contain the user of the equipment With most such equipment the railing will meet at right angles. The container is used by placing it on the rail at one of the right angle corners and placing is such that the attachment bracket fits over the railing. Once the container is placed onto the corner of the rail, it can be secured by placing a strap or other tying material through one or more perforations 19 on the attachment bracket and around the equipment's railing, The container can then be used to hold tools. materials, and supplies for the user.

While this invention has been described with the specific embodiments outlines above, the preferred embodiments set forth are intended to be illustrative, not limiting. Various changes may be made without departing, from the scope of the invention as defined in the following claims. The claims provide the scope of coverage of this invention and should not be limited to the specific examples cited above.

What is claimed is:

1. A rail mounted storage container comprising:
a storage body which is generally concave in shape having front and rear areas, multiple storage compartments which are separated by dividers, and walls which are tapered such that the bottom of the storage body is narrower than the top of the storage body and configured such that a left rear wall and a right rear wall are oriented perpendicular to one another;
an attachment bracket proximate the rear area of the storage body comprising multiple inner tabs which are affixed to a right rear outer side of the storage body and a left rear outer side of the storage body, a top surface which is affixed to the inner tabs, outer tabs which are affixed to the top surface, and perforations; and
an accessory rail proximate the front area of the storage body which is affixed to the storage body.

2. A rail mounted storage container comprising:
a storage body which is generally concave in shape having front and rear areas, a storage compartment, and walls which are tapered such that the bottom of the storage body is narrower than the top of the storage body and configured such that a left rear wall and a right rear wall are oriented perpendicular to one another;
an attachment bracket proximate the rear area of the storage body comprising multiple inner tabs which are affixed to a right rear outer side of the storage body and a left rear outer side of the storage body, a top surface which is affixed to the inner tabs, outer tabs which are affixed to the top surface, and perforations; and
an accessory rail proximate the front area of the storage body which is affixed to the storage body.

3. The rail mounted storage container of claim I where the storage body has three storage compartments

4. The rail mounted storage container of claim 1 where the inner tabs, top surface, and outer tabs are configured such that their cross section is in the shape of an inverted U.

5. The rail mounted storage container of claim 2 where the inner tabs, top surface, and outer tabs are configured such that their cross section is in the shape of an inverted U.

6. The rail mounted storage container of claim 1 where the perforations are configured as slots.

7. The rail mounted storage container of claim 1 where the perforations are configured as holes.

8. The rail mounted storage container of claim 2 where the perforations are configured as slots.

9. The rail mounted storage container of claim 2 where the perforations are configured as holes.
